(19) United States
(12) Patent Application Publication
(10) Pub. No.: US 2021/0213418 A1
(43) Pub. Date: Jul. 15, 2021

(54) SORBENT AND SORPTION DEVICE

(71) Applicant: University of Tasmania, Sandy Bay (AU)

(72) Inventors: Brett Paull, Hobart (AU); Chowdhury Kamrul Hasan, Hobart (AU); Pavel Nesterenko, Hobart (AU); Robert Shellie, Ringwood (AU)

(21) Appl. No.: 17/250,116

(22) PCT Filed: May 31, 2019
(86) PCT No.: PCT/AU2019/050566

§ 371 Date: Nov. 30, 2020

(30) Foreign Application Priority Data
May 31, 2018 (AU) 2018901934

(51) Int. Cl. B01J 20/26; B01D 15/08; C12H 1/056; C12H 1/044; B01J 20/20; B01J 20/28; B01J 20/285; G01N 1/40

(52) U.S. Cl. CPC B01J 20/262; B01D 15/08; C12H 1/0424; C12H 1/0408; B01J 20/20; B01J 2220/54; B01J 20/28004; B01J 20/28026; B01J 20/285; G01N 1/405; B01J 20/28011

(57) ABSTRACT

The invention relates generally to sorbents and sorption devices for extracting compounds. The invention relates to a sorbent comprising a polymer and microdiamond. The invention also relates to a sorption device comprising the sorbent. The invention further relates to methods of using the sorption device for extracting organic compounds from a fluid and for preparing a sample containing organic compounds for analysis.

### FIELD

The present invention relates to sorbents for extracting organic compounds. The present invention also relates to sorption devices comprising the sorbent. The present invention further relates to methods for extracting organic compounds from a fluid, and methods for preparing a sample containing organic compounds for analysis.

### BACKGROUND

Some polymers, including polysiloxanes such as poly(dimethylsiloxane) (PDMS), have the ability to sorb and desorb compounds and can be used as sorbents in sorption devices. These sorption devices can be used for extraction or pre-concentration of compounds. For example, sorption devices may be used in sample preparation techniques that involve sorption of compounds from a solvent onto or into the sorption device, and subsequent desorption of the compounds from the sorption is device to provide the sample.

PDMS is used as a sorbent in sorption devices and has favourable properties, including high hydrophobicity, thermal and oxidative stability, bio-compatibility, durability, and polymerisation flexibility. In addition, PDMS exhibits minimal swelling in polar solvents and maximal swelling in non-polar solvents, which allows efficient desorption of compounds from PDMS-based sorption devices. On the other hand, PDMS has relatively low density, and therefore does not sink in various solvents including water. Flotation of PDMS sorption devices reduces the contact surface area and decreases the sorption/extraction efficacy of the device. Whilst attempts have been made to address the density and/or efficacy of PDMS-based devices, there is more that can be done to produce more effective sorption devices and processes for the extraction of organic compounds using sorption devices.

Accordingly, the present application seeks to provide a sorbent that may solve one or more of the problems associated with current sorbents and sorption devices.

### SUMMARY

In a first aspect, there is provided a sorbent for extracting one or more organic compounds, comprising a porous polymer and microdiamond. The polymer may be selected from the group consisting of a polysiloxane, a polyamide, a polyimide, a polyethylene, a polyether, polyvinyl alcohol, polylactic acid, a polycarbonate, a polyepoxide, and co-polymers or blends thereof.

In a second aspect, there is provided a sorption device comprising the sorbent described above.

In a third aspect, there is provided a method for extracting one or more organic compounds from a fluid, the method comprising contacting:
i) a carrier fluid containing one or more organic compounds, and
ii) a sorbent comprising a polymer and microdiamond, wherein the polymer is selected from the group consisting of a polysiloxane, a polyamide, a polyimide, a polyethylene, a polyether, polyvinyl alcohol, polylactic acid, a polycarbonate, a polyepoxide, and co-polymers or blends thereof,
   so that one or more organic compounds are sorbed onto or into the sorbent.

In a fourth aspect, there is provided a method for preparing a sample containing one or more organic compounds for analysis, the method comprising:
a) contacting:
   i) a carrier fluid containing one or more organic compounds, and
   ii) a sorbent comprising a polymer and microdiamond, wherein the polymer is selected from the group consisting of a polysiloxane, a polyamide, a polyimide, a polyethylene, a polyether, polyvinyl alcohol, polylactic acid, a polycarbonate, a polyepoxide, and co-polymers or blends thereof,
   so that one or more organic compounds are sorbed onto or into the sorbent, and
b) desorbing the one or more organic compounds from the sorbent to provide the sample containing the one or more organic compounds for analysis.

In notable embodiments, the carrier fluid is a carrier solvent. Accordingly, there is a method for extracting one or more organic compounds from a solvent, the method comprising contacting:
i) a carrier solvent containing one or more organic compounds, and
ii) a sorbent comprising a polymer and microdiamond, wherein the polymer is selected from the group consisting of a polysiloxane, a polyamide, a polyimide, a polyethylene, a polyether, polyvinyl alcohol, polylactic acid, a polycarbonate, a polyepoxide, and co-polymers or blends thereof,
   so that one or more organic compounds are sorbed onto or into the sorbent.

There is also provided a method for preparing a sample containing one or more organic compounds for analysis, the method comprising:
a) contacting:
   i) a carrier solvent containing one or more organic compounds, and
   ii) a sorbent comprising a polymer and microdiamond, wherein the polymer is selected from the group consisting of a polysiloxane, a polyamide, a polyimide, a polyethylene, a polyether, polyvinyl alcohol, polylactic acid, a polycarbonate, a polyepoxide, and co-polymers or blends thereof, so that one or more organic compounds are sorbed onto or into the sorbent, and
b) desorbing the one or more organic compounds from the sorbent to provide the sample containing the one or more organic compounds for analysis.

In a fifth aspect, there is provided a method for the preparation of a sorbent comprising polymer-microdiamond composite, the method comprising:
combining a polymer precursor, microdiamond and curing agent to form a mixture,
shaping the mixture,
curing the mixture, and
drying the mixture to form the sorbent.

These aspects are described more fully in the detailed description below.

### BRIEF DESCRIPTION OF THE DRAWINGS

The invention will be described in further detail, by way of example only, with reference to the following Figures:

FIG. 1 presents images of a rod containing PDMS only (FIG. 1a) and a rod containing PDMS-microdiamond composite (FIG. 1b) in water.

FIG. 2 presents images of PDMS-microdiamond composites and PDMS-only materials.

FIG. 3 present graphs showing pore size distribution of porous PDMS-microdiamond composites determined from microscope images.

FIG. 4 presents images of PDMS-microdiamond composites in different forms.

FIG. 5 presents schematic drawings of PDMS-microdiamond composites as sorbents in different sorption devices.

FIG. 6 presents images of structural stability tests of a porous PDMS-microdiamond composite and a porous PDMS-only material.

FIG. 7 presents graphs showing thermal stability (FIG. 7a) and degradation rates (FIG. 7b) of PDMS-microdiamond composites and PDMS-only materials.

FIG. 8 presents chromatograms of leached siloxanes from PDMS-microdiamond composites using different purification methods.

FIG. 9 shows the kinetics of siloxanes leached from PDMS-microdiamond composites following soaking in methanol for different time periods.

FIG. 10 presents chromatograms showing signal intensity (FIG. 10a) and graphs showing chromatographic peak area (FIG. 10b) of organic compounds extracted from wine samples by solvent back extraction using PDMS-microdiamond composites and a commercially available PDMS device.

FIG. 11 presents graphs showing chromatographic peak area of organic compounds extracted from synthetic wine samples by solvent back extraction using a non-porous PDMS-microdiamond composite and a commercially available PDMS device.

FIG. 12 presents graphs showing percentage recovery of organic compounds extracted from synthetic wine samples by solvent back extraction using porous and non-porous PDMS-microdiamond composites and a commercially available PDMS device.

FIG. 13 presents graphs showing chromatographic peak area of organic compounds extracted from wine samples by solvent back extraction using porous and non-porous PDMS-microdiamond composites and a commercially available PDMS device.

### DETAILED DESCRIPTION

Unless defined otherwise, all technical and scientific terms used herein have is the same meaning as commonly understood by those of ordinary skill in the art to which the invention belongs. Although any methods and materials similar or equivalent to those described herein can be used in the practice or testing of the present invention, preferred methods and materials are described. For the purposes of this invention, the following terms are defined below.

The use of the terms “a” and “an” and “the” and similar referents in the context of describing the invention are to be construed to cover both the singular and the plural, unless otherwise indicated herein or clearly contradicted by context.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

The term “sorb” is a verb that encompasses adsorb and/or absorb. In the context of the present application, this refers to the adsorption and/or absorption of a compound or compounds from a fluid. “Sorbed”, “sorbs” and “sorbent” (i.e. a material that sorbs) have corresponding meanings. Where reference is made to compounds being sorbed onto or into a sorbent, this expression encompasses absorption or adsorption, or sorption through both mechanisms. Some polymers are known to have predominantly “adsorbent” properties, and others to have predominantly “absorbent” properties. If a particular mechanism of sorption is specified herein (e.g. absorption), then one may infer from the known properties of the polymer which mechanism of sorption is used.

### Sorbent

Described herein are sorbents that are capable of extracting one or more organic compounds from a fluid. The sorbent comprises a polymer and microdiamond. The sorbent may comprise a composite of polymer and microdiamond—a so-called polymer-microdiamond composite.

The polymer may be selected from the group consisting of polysiloxanes, polyamides, polyimides, polyalkylenes such as polyethylene, polyethers such as polyethylene glycol, polyvinyl alcohols, polylactic acids, polycarbonates, polyepoxide, and any co-polymers or blends thereof. The polymer may be selected from a sub-grouping of any one or more of the above polymers. In some embodiments, the polymer is a polysiloxane. In one embodiment, the polysiloxane is PDMS.

The polymer may be suitably prepared using one or more polymer precursors. For example, in embodiments where the polymer is PDMS, the polymer can be prepared from a silicone elastomer base. The selection of suitable polymer precursors for each of the alternative polymers described above is well known to those skilled in the art.

Suitable polymers for use in the sorbent have sorptive properties, that is, the polymer is capable of absorbing and/or adsorbing organic compounds. In preferred embodiments, the polymer has absorbent properties (rather than adsorbent properties)—that is, it is capable of absorbing organic compounds. PDMS is an example of a polymer having absorbent properties.

In preferred embodiments, the polymer is PDMS. PDMS has favourable properties making it suitable as the polymer base of the sorbent, including favourable sorptive properties. Studies conducted by Baltussen et al. (E. Baltussen, P. Sandra, F. David, H.-G. Janssen, C. Cramers, Study into the Equilibrium Mechanism between Water and Poly(dimethylsiloxane) for Very Apolar Solutes: Adsorption or Sorption? Analytical Chemistry, 1999, 71, 5213-5216) show that PDMS is capable of absorbing organic compounds from water. Nevertheless, PDMS has a relatively low density (0.96 g·cm⁻³) and therefore does not sink in some solvents, such as water. This causes floating of PDMS-based sorption devices in these solvents, which reduces the surface contact area and decreases the sorption/extraction efficacy of such devices. High-density fillers have previously been considered for incorporation into PDMS-based sorption devices, including carbon-based fillers, inorganic oxide fillers, and salt fillers. Nanodiamonds, such as detonation nanodiamond (DND) particles, have also been considered for use as a filler in PDMS devices. Nanodiamonds have a nano-range particle size (i.e. have an average particle size of at least 1 nm and less than 1 μm) and therefore are generally extremely fine-sized. The nano-scale size range of nanodiamonds gives rise to a relatively polar surface, which causes the particles to aggregate substantially in the PDMS precursor and consequently form aggregates within the PDMS matrix. This results in the PDMS-nanodiamond composites having low filler content (less than 3%) and inconsistent properties.

In contrast to such prior nanodiamond-based composites, the present sorbents comprise microdiamond. Microdiamond is a particulate diamond material having a particle size in the micrometre range (i.e. having an average particle size of at least 1 μm and less than 1 mm). The diamond may be natural or synthetic, however in general microdiamond is produced synthetically to achieve the desired particle size and other properties. Accordingly, in typical embodiments, microdiamond is a synthetic diamond and is synthesised under high temperature and high pressure.

Microdiamond has been used for different applications due to its physio-chemical properties including favourable hardness and thermal conductivity, and negligible linear thermal expansion. Unlike nanodiamond particles, the degree of polarity of the surface of the microdiamond relatively moderate (i.e. it is significantly less polar than nanodiamond). In the embodiments shown in the examples, PDMS-microdiamond composites are prepared that contain microdiamond in concentrations as high as about 60 wt. %, based on the total weight of the composition used to prepare the composites. In these embodiments, the microdiamond is shown to be dispersed throughout the composite and does not form aggregates in the composite. In addition, the thermal stability, thermal conductivity and mechanical robustness of the composite is improved compared to comparative polymer samples that do not contain microdiamond.

The polymer and microdiamond are typically in the form of a polymer-microdiamond composite. The composite is the polymerisation product of a composition comprising the relevant polymer precursor(s) and microdiamond. The microdiamond becomes interspersed in the polymer matrix as polymerisation occurs. Accordingly, the composite comprises the microdiamond dispersed throughout the polymer matrix. The microdiamond is thereby interspersed and entrapped throughout the polymer.

In some embodiments, the microdiamond provides a density to the polymer/polymer-microdiamond composite such that the sorbent sinks in a particular solvent. This allows the sorbent to become submerged in the solvent, which increases the contact surface area, and therefore the interactions of the polymer with the organic compounds. This leads to improved sorption of the organic compounds onto or into the sorbent and extraction of the organic compounds from the solvent.

Accordingly, in some embodiments, the microdiamond has a density suitable so as to allow the polymer (composite) to sink in a particular solvent. In some embodiments, the microdiamond has a density within the range of from about 2.0 g·cm⁻³ to about 4.0 g·cm⁻³. In some embodiments, the microdiamond has a density of about 3.5 g·cm⁻³. The reference to a density of about 3.5 g·cm⁻³, by way of example, means a density of 3.5 g·cm⁻³ plus or minus 0.5 g·cm⁻³.

The microdiamond may suitably have a particle size (i.e. an average particle size or particle size range) suitable to achieve the required density of the polymer (composite). In some embodiments, the microdiamond has a particle size within the range of from about 1 μm to about 40 μm. In some embodiments, the microdiamond has a particle size within the range of from about 1 μm to about 20 μm. In some embodiments, the microdiamond has a particle size within the range of from about 1 μm to about 10 μm. In some embodiments, the microdiamond has a particle size within range of from about 2 μm to about 4 μm. The particle size of microdiamond can be determined by conducting size fractionation, for example by a sedimentation process in which the microdiamond is washed with an aqueous base (e.g. 5 mM potassium hydroxide), and subsequently determining particle size distribution from scanning electron microscopy (SEM) images by using suitable analytical techniques, for example Image J software (National Institute of Health, USA). The particles in some embodiments have a relatively narrow particle size distribution. A distribution such that 95% of particles is within the range of 1-10 μm, preferably 1-8 μm, 1-6 μm, 2-6 μm or 2-4 μm, is preferred.

The microdiamond may present in an amount within the range of 5 wt. % to 80 wt. %, based on the total weight of the combination of polymer and microdiamond (e.g. the composite), or based on the total weight of the sorbent. The maximum amount of microdiamond may be not more than 75 wt. %, 70 wt. %, 65 wt. %, or 60 wt. %, based on the total weight of the combination of polymer and microdiamond, or the sorbent. The minimum amount may be at least 10 wt. %, 15 wt. %, 20 wt. %, 25 wt. %, 30 wt. %, 35 wt. %, 40 wt. %, 45 wt. %, 50 wt. %, or 55 wt. %, based on the total weight of the combination of polymer and microdiamond, or the sorbent. Any maximum and minimum value may be combined to form a range. The amount of microdiamond present may be suitably selected based on density and/or particle size of the microdiamond used. In some embodiments, the microdiamond is present in an amount within the range of 30 wt. % to 60 wt. %, or 35 wt. % to 60 wt. %, based on the total weight of the combination of polymer and microdiamond. In some embodiments, the microdiamond is present in an amount within the range of 15 wt. %-60 wt. %, or 30 wt. % to 60 wt. %, or 35 wt. % to 60 wt. %, based on the total weight of the sorbent.

The polymer may be present in an amount of within the range of 30 wt. % to 95 wt. %, based on the total weight of the combination of polymer and microdiamond (e.g. the composite), or based on the total weight of the sorbent. The maximum amount may be not more than 90 wt. %, 85 wt. %, 80 wt. %, 75 wt. %, 70 wt. %, 65 wt. %, or 60 wt. %, based on the total weight of the combination of polymer and microdiamond, or the sorbent. The minimum amount may be at least 35 wt. %, 40 wt. %, or 45 wt. %, based on the total weight of the combination of polymer and microdiamond, or the sorbent. Any maximum and minimum value may be combined to form a range. In some embodiments, the polymer is present in an amount within the range of 30 wt. % to 60 wt. %, preferably 35 wt. % to 60 wt. %, based on the total weight of the combination of polymer and microdiamond, or the sorbent. It is noted that the amounts of microdiamond and/or polymer above may also be made by reference to the total weight of the composition used to prepare the combination of polymer and microdiamond. The composition may include components other than polymer and microdiamond, such as a curing agent.

Where the sorbent consists entirely of a polymer-microdiamond composite, the calculation of the weight percent of microdiamond (and similarly the polymer) in the composite will be the same as the calculation of the weight percent of microdiamond in the total sorbent. However, it is noted that in some embodiments the sorbent could contain additional components, and in this case the amount of microdiamond (for example) by reference to the composite would be different (higher) compared to the amount of microdiamond by reference to the totality of the sorbent.

In some embodiments, the sorbent (or the polymer, or the polymer-microdiamond composite in particular) sinks in a particular solvent. For example, in embodiments where the solvent is water, the polymer has a density of greater than about 1.0 g·cm⁻³. In some embodiments, the polymer (or the composite in particular) has a density of greater than about 0.7 g·cm⁻³, or greater than about 1.0 g·cm⁻³. It is noted that while the amount and density of the microdiamond has an impact on the density of the sorbent, these are not the only factors that would determine whether or not the sorbent will sink in a particular solvent.

The polymer-microdiamond composite of the sorbent may comprise further materials in addition to those described above. The polymer-microdiamond composite may comprise one or more fillers, in addition to the required microdiamond and polymer. While microdiamond may be viewed as a “filler”, in the context of the present application, it is not considered to be a “filler” since it is an essential component for the efficacy of the sorbent. The term “filler” refers to carbon-based materials (other than microdiamond) such as carbon fibres, carbon nanotubes, graphene, graphene oxide and nanodiamond, inorganic oxides such as silicon dioxide and zinc oxide, and salts such as sodium chloride and sodium bicarbonate. These fillers may constitute an additional component of the polymer-microdiamond composite. In these embodiments, the amount of such fillers is preferably less (by total weight of the composite) than the weight of the microdiamond. The amount is preferably less than 60 wt. %, 50 wt. %, 40 wt. %, 30 wt. %, 20 wt. %, 10 wt. % or 5 wt. %, compared to the weight percent of microdiamond in the composite. Thus, as an example, where the amount of microdiamond is 40% by weight of the composite, the filler, if present, should constitute less than 24% by weight of the composite (i.e. 60% of the 40% amount of microdiamond). In embodiments where the filler is present, and the filler comprises or consists of nanodiamond, the nanodiamond is preferably present in an amount less than 10 wt. %, 7 wt. %, 5 wt. %, 3 wt. %, 2 wt. % or 1 wt. %, based on the total weight of the sorbent. In other embodiments, the sorbent is preferably free of nanodiamond, or substantially free of nanodiamond.

In addition to fillers, the polymer-microdiamond composite may contain residual reagents and/or by-products of the cross-linking process involved in the production of the polymer, and may additionally include surfactants.

The sorbent used in the methods of the present application (or the polymer/polymer-microdiamond composite in particular) may be porous or non-porous. However, in some embodiments, the polymer (the composite) must be porous. The term “porous” in relation to the sorbent refers to the presence of pores on the surface of and throughout the sorbent. Whether or not a polymer meets the definition of being “porous” (and whether or not the pores are on the surface and throughout the sorbent) can be determined by one of two main ways. The first technique involves assessing the method of manufacture to determine whether pores are specifically created in the polymer, such as by the inclusion of a porogen. A second technique involves taking an SEM image of a cross-section through the sorbent, and studying the SEM image using suitable software available in the art, to identify the presence and location/distribution of the pores. Those familiar with such techniques would be able to deduce whether a particular product has a sufficient distribution of pores such as to meet the requirement that the sorbent has pores at the surface and throughout the sorbent. The pore size and distribution within the sorbent can be determined from SEM images by using suitable analytical techniques, for example Image J software (National Institute of Health, USA). The porosity of the sorbent can be estimated from the following equation:

Porosity=Aₚ/A_{T}

where Aₚ=total area of pores in each cross-section of the SEM images of the sorbent, and A_{T}=total area of each cross-section, as described in Zargar et al. (Zargar, R., J. Nourmohammadi, and G. Amoabediny, Preparation, characterization, and silanization of 3D microporous PDMS structure with properly sized pores for endothelial cell culture. Biotechnology and Applied Biochemistry, 2016, 63(2), p. 190-199). The porosity will be above 1% and will typically be less than 70% using this measurement. In some embodiments, the porosity is greater than 10%, 20% or 30%. In some embodiments, the porosity is less than 70%, 65% or 60%. Any maximum and minimum value may be combined to form a range. Advantageously, porous sorbents (i.e. porous polymers, and porous polymer-microdiamond composites) have an increased surface area compared to non-porous analogues, which allows for improved sorption of the organic compounds onto and/or into the sorbent and extraction of the organic compounds.

### Form of Sorbent, and Sorption Devices Comprising the Sorbent

The sorbent may be configured into any desired shape or incorporated into any suitable apparatus for sorbing (absorbing and/or adsorbing) solutes from a solution. The sorbent may, for example, be in the form of solid rod or a hollow rod, a sphere, a disk, a membrane, a film, a fibre, a coating or a particle. In some embodiments the sorbent (or the sorption device in particular) is not in particle form. Thus, in such embodiments, each indivisible piece or unit of the sorbent is at least 0.1 g in weight.

In some embodiments, the sorbent is in the form of a sorption device, or the sorbent forms a component of a sorption device.

Accordingly, the present application extends to sorption devices that comprise the sorbent described above. The sorption devices are useful for extracting organic compounds from a fluid and can be used for extraction or pre-concentration of compounds from fluids.

In some embodiments, the sorption device substantially consists of the sorbent. That is, the sorbent constitutes a minimum of 90%, 95% or 98% by weight of the sorption device. The sorption device may in some embodiments consist entirely of the sorbent. Expressed another way, the sorption device may consist entirely of the polymer-microdiamond composite. In these embodiments, the expression “sorption device” can be used interchangeably with “sorbent”.

In some embodiments, the sorption device comprises a solid substrate. In these embodiments, the sorbent may be present as a coating on the substrate. For example, the composite can be in the form of a coating on a substrate in the form of a rod, channel, fibre, column, plate, or otherwise. The substrate may be formed of any suitable material, such as glass (including fused silica), metal (including stainless steel and platinum), magnetised metal or otherwise.

The sorption device may be in any shape or geometric form. The sorption device may, for example, be in the form of solid rod or a hollow rod, a column, a sphere, a disk, a membrane, a film, a filter, a fibre, or a particle. In preferred embodiments, the sorption device has a form or shape suitable for a particular application of the sorption device. For example, for use in stir bar sorptive extraction, the sorption device can be in the form of a rod. The rod may be solid or hollow. The sorption device in the form of a rod can be useful for stir bar sorptive extraction. In addition, the sorption device in the form of a rod (either solid or hollow) can be used inside a glass insert or tube as a platform for a thermal desorption unit. In some embodiments, the sorption device is in the form of a sphere. Substantially spherical sorption devices are encompassed by the term “sphere”. The sorption device in the form of a sphere can be useful for passive sampling of analytes from an aqueous solution. In embodiments where the sorption device is in the form of a film or a membrane, it can be useful for thin film extraction. In embodiments where the sorption device is in the form of a fibre, it can be useful for solid phase microextraction. In embodiments where the sorption device is in the form of particles, the particles may be regular or irregular in shape. The sorption device in the form of particles can be useful for particle bed extraction, such as microextraction by packed sorbent (MEPS).

The sorbent or sorption device (or the polymer/polymer-microdiamond composite in particular) is preferably able to withstand a temperature of about 500° C. under nitrogen atmosphere for 10 minutes and/or about 425° C. in air for 10 minutes with less than about 10% weight loss. In the embodiments shown in the examples, the polymer-microdiamond composite is shown to have good thermal stability, thermal conductivity and mechanical robustness. The results indicate the suitability of the composite for use in thermal desorption, without degradation. This surprisingly applies to porous composites. As shown in the examples, porous PDMS-based sorbents were shown to disintegrate after a single extraction sequence, whereas the porous PDMS-microdiamond sorbents were shown to retain their rigidity and integrity after several sequences. An advantage of mechanical robustness and thermal stability is that the sorption device will be capable of being re-used multiple times in multiple sorption-desorption sequences without excessive degradation and without having any carryover effect while maintaining sorption efficiency.

### Preparation of the Sorbent

The sorbent (or the polymer-microdiamond composite in particular) may be suitably prepared from a composition comprising one or more polymer precursors, microdiamond and a curing agent. The composite can be prepared without technical difficulty, using techniques known in the art for the polymer base, and with suitable modifications to allow the incorporation of the microdiamond particles.

The composite may be prepared by combining polymer precursor(s), microdiamond and curing agent (e.g. by mixing the one or more polymer precursors and the microdiamond, adding the curing agent to the mixture), shaping the mixture into the desired form (e.g. through simply casting the mixture or moulding the mixture into the desired form), curing the mixture, and drying the mixture to provide the sorption device. Curing and drying may be performed together or separately. The composite can be prepared in various shapes or forms, depending on the mould used to cast the composites. The composite is preferably shaped into units having a dried weight of at least 0.1 g. Thus, it is preferred to avoid the preparation of a particulate material containing only single or small numbers of microdiamond particles in each unit.

In embodiments where the polymer (composite) is porous, the composite may be prepared by combining polymer precursor(s), microdiamond, curing agent and a porogen (e.g. by mixing the one or more polymer precursors and the microdiamond, adding the curing agent to the mixture, adding a porogen to the mixture), casting the mixture, curing the mixture, removing the porogen from the cured mixture, and drying the cured mixture to provide the porous sorption device. The polymer precursor(s), microdiamond, curing agent and porogen are suitably combined in such a manner as to ensure the uniform distribution of the porogen throughout the mixture, which leads to the formation of pores throughout the final polymer-microdiamond composite product. The homogeneous distribution of the porogen within the mixture allows for the formation of a porous polymer-microdiamond composite that contains pores from the core to the periphery of the composite. The use of porogens can also allow for control of the pore size and porosity of the composite. Suitable porogens include inorganic salts and sugars, which may, for example, be in the form of particles. Suitable inorganic salts include sodium chloride, sodium bicarbonate, calcium chloride, lithium chloride, calcium carbonate, ammonium bicarbonate, and mixtures thereof. The inorganic salts may be any size suitable for forming pores in the sorption device. For example, the inorganic salts may have a particle size within the range of 1-300 μm, 50-300 μm, 50-200 μm, 100-300 μm, 50-200 μm, 10-100 μm, 66-100 μm, 1-50 μm, 1-20 μm, 1-10 μm, or 1-5 μm. The inorganic salts may be removed from the cured mixture by leaching or dissolution, for example by soaking the cured mixture in acid (e.g. a strong acid such as hydrochloric acid) and subsequently boiling in water. Sugar particles can also be removed from the cured mixture by soaking the cured mixture in water.

Porous polymers can alternatively be prepared using other methods known in the art, for example using the methods described in Wu, D., et al., Design and preparation of porous polymers, Chemical Reviews, 2012, 112(7): p. 3959-4015.

In preferred embodiments, the polymer precursor is a PDMS precursor such as a silicone elastomer base. In the embodiments shown in the examples, the polymer composite is prepared using Sylgard 184 (Dow Corning, USA) base and curing agent. In these embodiments, microdiamond forms stable homogenous suspensions with the PDMS precursor, unlike nanodiamond, which tends to aggregate. The curing agent may be selected from any curing agent known in the art to be suited to the curing of the relevant polymer.

The preparation of the polymer-microdiamond composite may further comprise a cleaning step. The cleaning step may comprise soaking in a suitable solvent, such as an alcohol (e.g. methanol) for a time period of at least 1 hour, such as 2, 3 or 4 hours. The soaking time period may be as high as about 24 hours, about 48 hours, or more. The soaking temperature may be at or above ambient, and is preferably an elevated temperature. The temperature may be around the boiling point of the solvent. A suitable temperature may be between 60° C. and 80° C. The cleaning step may comprise Soxhlet extraction in methanol, toluene, or a combination thereof. The time period may be about 48 hours or 72 hours.

The preparation of the composite may additionally (or alternatively to the Soxhlet extraction cleaning step) comprise thermal treatment of the composite. The thermal treatment may comprise exposure to elevated temperatures for a time period of at least 15 minutes, such as at least 30, 45 or at least about 60 minutes. The elevated temperature may be at least 100° C., 150° C., 200° C., 250° C., 300° C., 350° C., or 400° C. The temperature may be about 280° C. or more than 300° C. This may be conducted in an inert gas atmosphere, such as in a nitrogen gas atmosphere or a helium gas atmosphere. Thermal treatment has been found to decrease the release of potential siloxane impurities from the composite during later use of the composite in sorption/desorption processes.

### Application of the Sorption Device

Described herein are methods and uses of the sorbent and the sorption device described above for extracting one or more organic compounds from a fluid. Also described herein are methods for preparing a sample containing one or more organic compounds for analysis. The sorption device can be used in various sample preparation techniques, such as stir bar sorptive extraction, solid phase microextraction, particle bed extraction, and thin film extraction. The sorption device is particularly useful for solid phase microextraction sample preparation. The sorbent can be used in chromatography systems, such as in chromatographic columns where the sorbent forms the stationary phase of the column.

The fluid containing the one or more organic compounds, also referred to herein as a carrier fluid, refers to a fluid containing molecules of at least one species of organic compound. The term “fluid” encompasses liquids, such as solvents, and gases. In embodiments where the carrier fluid contains two species of organic compound, the sorption device may be capable of sorbing only one of the species, or both species. In embodiments where the carrier fluid contains more than two species of organic compound, the sorption device may be capable of sorbing only one of the species, some of the species, or all of the species. The species of organic compounds may include polar compounds and/or non-polar compounds. The polymer of the sorption device may be suitably selected so as to sorb polar compounds, non-polar compounds, or both.

The methods of the present application involve an extraction step, which comprises contacting a carrier fluid (which may be a solvent or a gas) containing one or more organic compounds and the sorption device comprising the sorbent described above, so that said one or more organic compounds (i.e. one, some, or all species of organic compound in the carrier fluid) are sorbed onto or into the sorption device. This extraction step equally applies to embodiments where the carrier fluid is a carrier solvent and embodiments where the carrier fluid is a carrier gas. Therefore, in embodiments of the method of the application that involve one or more of the further steps described below, these further steps apply regardless of whether the extraction step involves contacting the sorbent with a carrier fluid or a carrier gas. Further, where the sorbent is described herein as being capable of sorbing one or more organic compounds from a solvent, it will be understood that the sorbent is capable of sorbing the one or more organic compounds from a gas.

In preferred embodiments, the carrier fluid is a carrier solvent. The carrier solvent may be any solvent suitable for containing the one or more organic compounds. The carrier solvent may be a polar solvent or a non-polar solvent. Advantageously, polymers such as PDMS exhibit minimal swelling in polar solvents. In some embodiments, the carrier solvent is water. The carrier solvent can include, for example, biological fluid, river or ocean water samples, and food or beverage samples.

Accordingly, in some embodiments, the extraction step comprises contacting a carrier solvent containing one or more organic compounds and the sorption device comprising the sorbent described above. In some embodiments, the contacting step comprises mixing the carrier solvent and the sorption device. In some embodiments, the contacting step comprises passing or running the carrier solvent through the sorption device, for example in embodiments where the sorption device is the stationary phase of a chromatographic system. Any other suitable form of contacting may alternatively be used.

In other embodiments, the carrier fluid is a carrier gas. Accordingly, in some embodiments, the extraction step comprises contacting a carrier gas containing one or more organic compounds and the sorption device comprising the sorbent described above. The carrier gas may be a transitional environment, such that the organic compounds to be identified are originally located in a solid or liquid sample, and pass into a gas in contact with the solid or liquid sample, prior to being sorbed into or onto the sorbent from the gas. In one specific example, the mode of sorption may be described as “headspace sorption”. Headspace sorption involves providing a solid or liquid sample in a sealed or gas-tight container, where volatile organic compounds of the sample enter the headspace (i.e. the gas phase above the sample) to provide the carrier gas containing one or more organic compounds, and contacting the carrier gas and the sorbent as described above. The solid or liquid samples from which the organic compounds are obtained (and from which the compounds pass into the carrier gas) can include, for example, river or ocean water or sediment samples, food and beverage samples, and samples derived from animal sources or plant sources (e.g. plant materials such as leaves).

The methods of the present application may also involve a desorption step, which comprises desorbing the organic compounds (i.e. the molecules of the organic compound(s) that sorbed onto or into the sorption device) from the sorption device to provide the sample containing the organic compounds for analysis.

In some embodiments, the desorbing step comprises heating the sorption device so that the organic compounds vapourise and are thereby desorbed from the sorption device (thermal desorption). Advantageously, the sorption device can be adapted to be suitable for use in commercially available thermal desorption units, such as the automated Gerstel Thermal Desorption Unit or other commercially available thermal desorption units (TDUs are being commercialised by other companies such as Markes International, Agilent Technologies). For example, the sorption device in the form of a rod can be utilised within a glass insert or tube, which provides a platform for headspace injection of analyte vapour followed by gas chromatography-mass spectrometry analysis. Desorption may therefore be by way of releasing the sorbed organic compound(s) into a gas.

In some embodiments, the desorbing step comprises contacting the sorption device with a desorption solvent, for example by mixing, so that the organic compounds are desorbed from the sorption device into the desorption solvent. Such techniques may be referred to as liquid desorption or solvent back-extraction. The desorption solvent may be any solvent suitable for desorbing the organic compounds from the sorption device. The desorption solvent may be polar or non-polar. Advantageously, polymers such as PDMS exhibit maximal swelling in non-polar solvents. Non-polar or substantially non-polar solvents are highly soluble in PDMS, which allows these solvents to penetrate the PDMS matrix. These characteristics allow for more effective desorption of compounds from the sorption device. The desorption solvent may therefore be a non-polar or substantially non-polar solvent. In some embodiments, the desorption solvent is selected from methanol, ethanol, nitromethane, acetonitrile, acetone, ethyl acetate, pentane, xylene, hexane, heptane, isooctane, cyclohexane, toluene, benzene, halogenated solvents such as chloroform and trichloroethylene, ethers such as diethyl ether, dimethoxyethane and tetrahydrofuran, diisopropylamine, and triethylamine. The selection of suitable desorption solvents may be a grouping of any one or more of the above listed desorption solvents. In some embodiments, the desorption solvent is methanol.

The methods of the present application may further involve an analysis step, which comprises analysing the sample containing the organic compounds. In some embodiments, the analysis step comprises separating the organic compounds where there is more than one species of organic compound in the sample, for example by using chromatography such as liquid chromatography or gas chromatography. In some embodiments, the analysis step comprises detecting the presence of the organic compounds, for example using mass spectrometry or a flame ionisation detector (FID). In some embodiments, the analysis step comprises both separating the organic compounds and detecting the presence of the organic compounds, for example using gas chromatography-mass spectrometry (GC-MS) analysis, liquid chromatography-mass spectrometry (LC-MS) analysis or gas chromatography with flame ionisation detection (GC-FID) analysis.

The sorbent or sorption device can be re-used multiple times. For this to be possible, the sorbent or sorption device must be capable of being cleaned so as to avoid contamination of organic compounds from one mixture being analysed to the next (i.e. contamination between sequential extractions). It is a major advantage for a sorbent or sorption device to be able to be cleaned through a simple and relatively quick procedure that effects complete cleaning. The cleaning needs to be sufficient to reduce residual organic compound levels (contaminants) to below detectable levels in the analytical equipment. The sorbent/sorption devices of embodiments described herein have this feature.

As a consequence, the method for the preparation of a sample may comprise re-using the sorption device multiple times to complete multiple sample preparations.

The method may comprise cleaning of the sorption device and re-using the cleaned sorption device in a method for the preparation of a subsequent sample for analysis. Specifically, the method may comprise performing steps (a) and (b), cleaning the device, and repeating steps (a) and (b) with another combination of carrier fluid and organic compounds requiring analysis. The combination of carrier fluid with organic compounds to be separated from the carrier fluid may be referred to by the term “specimen” for brevity. Thus, the method may comprise performing steps (a) and (b) using a first specimen, cleaning, and performing steps (a) and (b) using a second specimen.

The cleaning may comprise thermal treatment. It has been found that the composite can be effectively cleaned by thermal treatment only. The thermal treatment may be as described above in the context of the preparation of the sorbent (i.e. heat treatment for at least 15 minutes at a temperature of at least 100° C., preferably at least about 280° C. or more than 300° C.). Cleaning can be effectively achieved without any Soxhlet extraction step. The ability for the sorbent/sorption device to be cleaned by thermal treatment only provides an advantage over some prior art products which require environmentally-unfriendly Soxhlet solvents. The fact that the device can withstand several stages of thermal treatment (i.e. at least one thermal treatment) without degradation also contributes to the cost-effectiveness of the device.

The sorbents, sorption devices and methods described herein can be used in several areas of application involving analysis of samples, including in environmental sciences, biotechnology and pharmaceuticals, drug screening and forensics, food and beverages, consumer products, chemicals and polymers, material emissions, flavour and fragrances.

### EXAMPLES

The present invention will now be described with reference to the following non-limiting Examples.

### Preparation of PDMS Rods With and Without Microdiamond

Porous and non-porous PDMS rods with microdiamond (samples 1, 3-8 and 11) and without microdiamond (comparatives samples 2 and 9-10) were prepared according to the compositions set out in Table 1.

TABLE 1

| | | Mass ratio | | | | | | |
|---|---|---|---|---|---|---|---|---|
| | | (PDMS: | | Curing | | | | Mean |
| Sample | Type of | curing | PDMS | agent | MD | NaCl | NaHCO₃ | density |
| No. | material | agent:MD) | (g) | (g) | (g) | (g) | (g) | (g.cm⁻³) |
| 1 | non- | 58.48: | 10.0 | 1.0 | 6.1 | 0.00 | 0.00 | 1.58 |
| | porous | 5.85: | | | | | | |
| | | 35.67 | | | | | | |
| 2 | non- | 90.91: | 10.0 | 1.0 | 0.00 | 0.00 | 0.00 | 1.17 |
| | porous | 9.09: | | | | | | |
| | | 0.0 | | | | | | |
| 3 | porous | 71.05: | 5.03 | 0.52 | 1.53 | 15.80 | 8.50 | 0.62 |
| | | 7.34: | | | | | | |
| | | 21.61 | | | | | | |
| 4 | porous | 75.76: | 3.50 | 0.35 | 0.77 | 7.9 | 4.25 | 0.85 |
| | | 7.58: | | | | | | |
| | | 16.67 | | | | | | |
| 5 | porous | 71.61: | 3.33 | 0.33 | 0.99 | 7.9 | 4.25 | 0.70 |
| | | 7.10: | | | | | | |
| | | 21.29 | | | | | | |
| 6 | porous | 64.04: | 3.33 | 0.33 | 1.54 | 6.83 | 3.68 | 0.73 |
| | | 6.35: | | | | | | |
| | | 29.62 | | | | | | |
| 7 | porous | 36.80: | 3.33 | 0.33 | 5.39 | 5.36 | 2.89 | 1.60 |
| | | 3.65: | | | | | | |
| | | 59.56 | | | | | | |
| 8 | non- | 36.80: | 3.33 | 0.33 | 5.39 | 0.00 | 0.00 | 1.98 |
| | porous | 3.65: | | | | | | |
| | | 59.56 | | | | | | |
| 9 | porous | 90.98: | 3.33 | 0.33 | 0.00 | 5.36 | 2.89 | 0.59 |
| | | 9.02: | | | | | | |
| | | 0.0 | | | | | | |
| 10 | non- | 90.98: | 3.33 | 0.33 | 0.00 | 0.00 | 0.00 | 1.18 |
| | porous | 9.02: | | | | | | |
| | | 0.0 | | | | | | |
| 11 | porous | 36.79: | 3.94 | 0.40 | 6.37 | 5.36 | 2.89 | 1.51 |
| | | 3.73: | | | | | | |
| | | 59.48 | | | | | | |

To prepare the rods in Table 1, the following materials were used. Sylgard 184 silicone elastomer base and curing agent were obtained from Dow Corning Corporation (Midland, Mich., USA). Microdiamonds (MD, particle size 2-4 μm, density=3.5 g·cm⁻³) were obtained from Hunan Real Tech Superabrasive & Tool Co. Ltd. (Changsha, Hunan, China). Sodium chloride (NaCl), L-(+)-tartaric acid, isoamyl acetate, ethyl hexanoate, ethyl octanoate, ethyl decanoate, phenethyl acetate and 2-octanol were obtained from Sigma-Aldrich (St. Louis, Mo., USA). Sodium bicarbonate (NaHCO₃), sodium hydroxide (NaOH), acetone, acetonitrile (ACN), dichloromethane (DCM), n-pentane and toluene were obtained from Chem-Supply Pty Ltd (Gillman, SA, Australia). Hydrochloric acid (HCl) was obtained from Merck (Darmstadt, Hessen, Germany). HPLC-grade methanol was obtained from Fisher Chemical (Fair Lawn, N.J., USA). Absolute ethanol was obtained from LabServ, Thermo Fisher Scientific Australia Pty Ltd (Scoresby, VIC, Australia). Milli-Q system (Millipore, Melbourne, Australia) was used for obtaining deionised water (DIVV). Poly(vinylchloride) (PVC) tubing (part no. PV00-3062C, 3 mm I.D.) was purchased from Value Plastics (USA).

The porous PDMS-MD composite rods in Table 1 (samples 3-7 and 11) were prepared according to the following procedure. The MD were mixed with the silicone elastomer base in a plastic container, followed by ultrasonication of the mixture for 30 min (Part A) using ultrasonic bath. Then curing agent was added to the mixture (base to curing agent ratio about 10:1) and degassed in a vacuum for 30 min. Crystals of NaCl and NaHCO₃ were ground either manually with a mortar and a pestle and sieved through 100-300 μm, 50-200 μm or 66-100 μm range of sieves, or by using a mechanical grinder to a particle size range of 4-7 μm as measured using an optical microscope (Leica DM LM modulated with a digital microscope camera Leica DMC 400, Leica Microsystems, Wetzlar, Germany). The mixture of NaCl (65 wt. %) and NaHCO₃ (35 wt. %) particles was then homogenised in a plastic container (Part B). Following a thorough manual mixing of Part A and Part B, the mixture was cast in a 3 cm piece of PVC tubing and cured at 110° C. for 30/60 min in an oven. After curing, a high pressure of air was applied to the PVC mould to remove the composite rod from the tubing. The embedded inorganic salts particles were removed from the polymer-diamond base by etching with 1M HCl in a glass beaker for 24 hours and subsequently boiling in de-ionised water for 5 hours. Finally, the rods were dried in oven at 100° C. for 1 hour, resulting in rod shapes of 10 mm length and 3.0 mm diameter, similar in dimensions to commercial PDMS extraction stir bars. For samples without MD (comparative samples 2, 9 and 10), a similar procedure was used except no MD were added. For non-porous samples (samples 1 and 8 and comparative samples 2 and 10), no inorganic salts were added.

The density of each sample was determined based on the ratio of the calculated volume of the rod (V=πR²L) and the experimentally measured mass of the dry rod. The mean density of each sample was calculated based on the density of 3 samples.

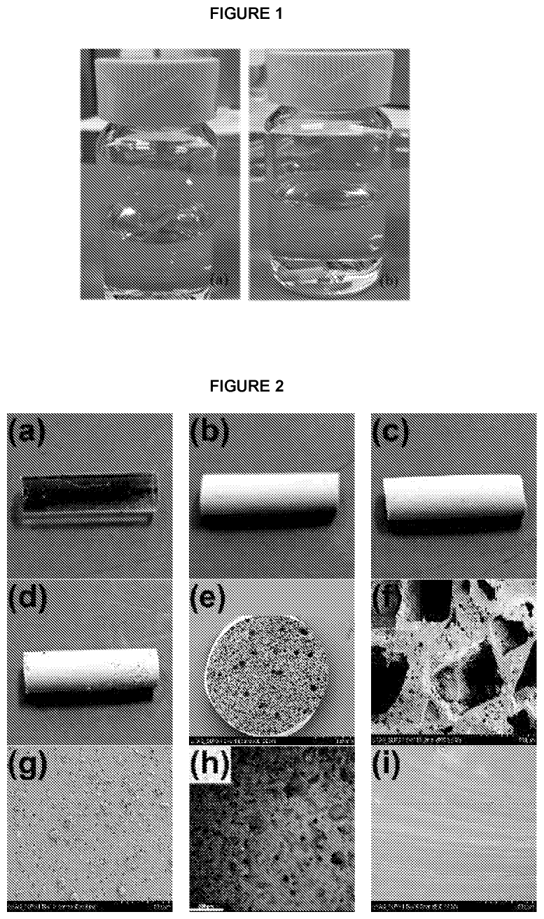

Samples 1 and comparative sample 2 are non-porous rods. These samples were prepared using the same amounts of PDMS precursor and curing agent, however sample 1 contains MD whereas comparative sample 2 does not. Comparative sample 2 was found to float in aqueous solution (FIG. 1a) and was calculated to have a mean density of 1.17 g·cm⁻³. It is noted that although comparative sample 2 has a higher calculated density than water, the relatively high hydrophobicity of the PDMS matrix may have caused the sample to float in the aqueous solution. Sample 1 was found to sink in aqueous solution (FIG. 1b) and was calculated to have a mean density of 1.58 g·cm⁻³. Therefore, the incorporation of about 35.7% (w/w) of MD to the PDMS matrix in sample 1 resulted in an increase in density of about 35%. These results demonstrate that the addition of MD to PDMS can increase the density of the composite to a level sufficient to allow the composite to sink in aqueous solution.

Various porous samples were prepared using NaCl and NaHCO₃ to form the pores in the PDMS-MD composites. Sample 3 was prepared using NaCl having a particle size ranging from 100-300 μm and NaHCO₃ having a particle size ranging from 50-200 μm. This sample was calculated to have a density of 0.62 g·cm⁻³. Samples 4 to 7 were prepared using NaCl and NaHCO₃ having a smaller particle size of 66-100 μm. Sample 4 contains slightly less MD than sample 3, but was calculated to have a density of 0.85 g·cm⁻³, which is greater than the density of sample 3. This difference in density may be due to the pores in sample 4 having a smaller pore size than those of sample 3, based on the smaller particle size range of the inorganic salts used to form the pores in sample 4. In samples 5-7, the effects of increasing MD and decreasing the amount of inorganic salts were investigated. Sample 7 was found to be the most dense, with a calculated mean density of 1.60 g·cm⁻³. Sample 8 is a non-porous analogue of claim 7, and was calculated to have a mean density of 1.98 g·cm⁻³. Sample 11 was prepared using NaCl and NAHCO₃ having a particle size of 4-7 μm. This sample was calculated to have a mean density of 1.51 g·cm⁻³.

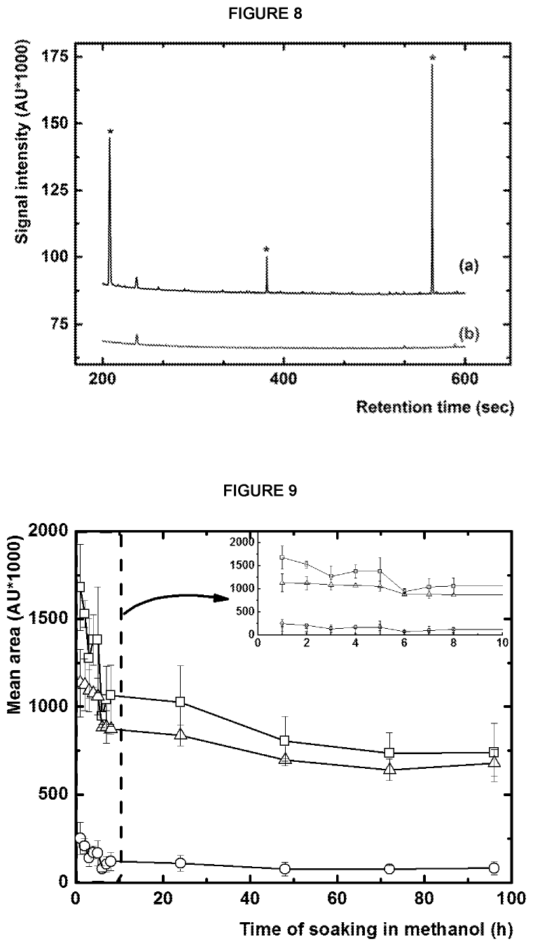

Sample 7 and sample 8 were found to be the most dense of the prepared porous and non-porous PDMS-MD composites, respectively. Both of these samples were found to sink in aqueous solution. Comparative samples 9 and 10 (FIG. 2a) are analogues of samples 7 (FIGS. 2b) and 8 (FIG. 2c), respectively, that do not contain MD. These comparative samples were calculated to have lower mean densities (0.59 g·cm⁻³ and 1.18 g·cm⁻³, respectively) and were found to float in aqueous solution. It is noted that although comparative sample 10 has a higher calculated density than water, the relatively high hydrophobicity of the PDMS matrix may have caused the sample to float in the aqueous solution. Therefore, the incorporation of about 60% (w/w) of MD to the PDMS matrix in samples 7 and 8 resulted in an increase in density of the composite of about 170% and about 70%, respectively. It is noted that the calculation of the amount of MD in the composite (as a weight %) is by reference to the total amount of polymer pre-cursor, curing agent and microdiamond, and the amount of porogen (which is subsequently removed) is not included in the calculation. Sample 11 (FIG. 2d) is a porous PDMS-MD composite that was also found to have a high density. Sample 11 has the smallest pore size of the porous samples, based on the smaller particle size range of the inorganic salts used to form the pores in the sample. Sample 11 was found to sink in aqueous solution.

The above results demonstrate that high amounts of MD can be incorporated into the PDMS matrix. This is unlike nanodiamond, which can only be incorporated in relatively small amounts (less than 3% by weight of the composite). The results also demonstrate that the incorporation of MD into PDMS matrix can increase the density of the composite to a level sufficient to allow the composite to sink in aqueous solutions. Morphology of PDMS-MD composites

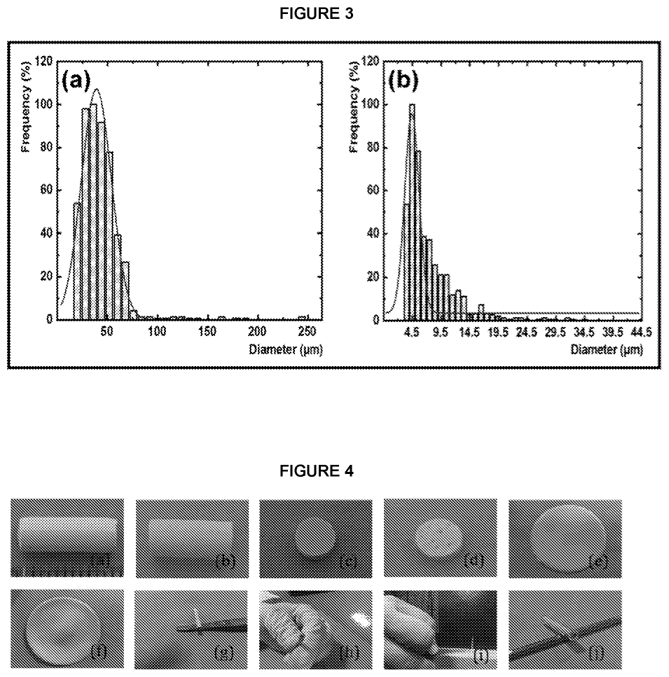

The surface morphology of samples 7, 8 and 11 was investigated employing a Hitachi SU-70 (Hitachi Ltd., Chiyoda, Tokyo, Japan) field emission scanning electron microscope (SEM) and 1.5 KeV of electron beam. FIG. 2 illustrates SEM images of sample 7 (FIG. 2e) and magnification of a section of this porous PDMS-MD composite (FIG. 2f), a SEM image of sample 8 (FIG. 2g), and a SEM image of sample 11 (FIG. 2h). For comparison, a SEM image of a non-porous PDMS-only sample is also shown (FIG. 2i). These figures show that the PDMS-MD composites have a homogenous structure and the MD are well dispersed in both the porous and non-porous composites. This is in contrast to PDMS-nanodiamond composites, which tend to contain aggregates of nanodiamond within the composites. This could be due of the moderate hydrophobicity of MD, which may allow the MD to remain dispersed throughout the hydrophobic PDMS polymer during polymerisation without aggregating. FIG. 2f also shows that sample 7 has pores reflecting the size range of salt particles used as templates for this sample (66-100 μm). The average pore size for sample 7 was found to be about 39 μm (FIG. 3a). The average pore size for sample 11 was found to be about 5 μm (FIG. 3b), which reflects the size range of salt particles used as templates for this sample (4-7 μm). This suggests that the pore size of the composite could be controlled depending on the size of the inorganic salt particles used to form the pores. Sample 7 was calculated to have a porosity of 40.5% and sample 11 was calculated to have a porosity of 56.5%.

### Preparation of PDMS-MD Composites in Different Forms

The PDMS-MD composites can be prepared in various forms. FIG. 4 illustrates PDMS-MD composites prepared in different forms, including a non-porous rod (FIG. 4a), a porous rod (FIG. 4b), a non-porous disk (FIG. 4c), a porous disk (FIG. 4d), a non-porous film (FIG. 4e), a porous film (FIG. 40, a non-porous hollow rod (FIG. 4g), a porous hollow rod (FIG. 4h), a fibre (FIG. 4i), and a hollow rod sitting inside a glass insert (FIG. 4j), which can be used as a platform for a thermal desorption unit. The solid rods were prepared by casting the mixture in a PVC tube (length 3 cm, internal diameter 3 mm). The hollow rods were prepared by inserting a polyether ether ketone (PEEK) tube (3/16 inch outer diameter) into the PVC tube, and removing the PEEK tube after the curing the mixture. While making the hollow rods, some of the mixtures entered the PEEK tube, which formed a narrow fibre (similar to inner diameter of the PEEK tube) after curing. The disks were prepared from the solid rods by slicing the rods composites with a sharp blade. The thin films were prepared by spin coating of the composite mixtures. The PDMS-MD composites shown in FIGS. 4a, 4c, 4g and 4i have a similar composition to sample 7 in Table 1. The PDMS-MD composites shown in FIGS. 4b, 4d, 4h and 4j have a similar composition to sample 8 in Table 1. The PDMS-composite shown in FIG. 4e was prepared using 6 g PDMS. 0.6 g curing agent and 5.39 g MD. The PDMS-composite shown in FIG. 4f was prepared using these ingredients, as well as 5.36 g NaCl and 2.89 g NaHCO₃ to form the pores.

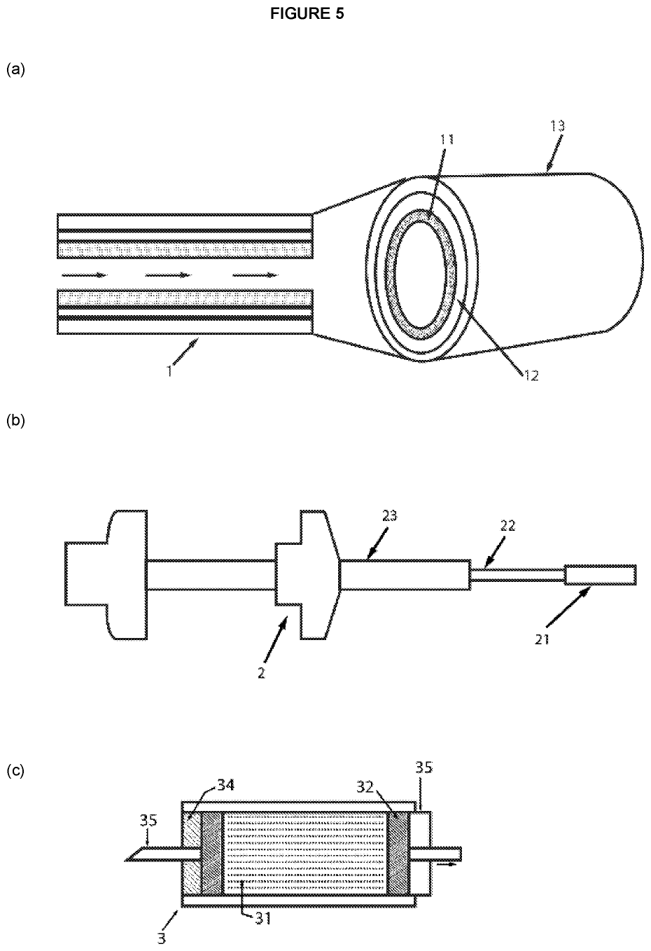

FIG. 5 shows schematic drawings of PDMS-MD composites in different forms useful for certain applications. FIG. 5a illustrates a gas chromatography capillary column for use in gas chromatography. The column 1 has an inner coating of PDMS-MD composite 11 as a stationary phase on a fused silica layer 12 of a polyimide resin column 13. The column 1 may have a length of about 10-100 m, an inner diameter of 0.1-0.53 mm and a stationary phase film thickness of about 0.5-5 μm. FIG. 5b illustrates a solid phase microextraction (SPME) fibre holder for use in SPME. The fibre holder 2 has a coating of PDMS-MD composite 21 on a rod or fused fibre 22 of a needle 23. The PDMS-MD composite coating 21 may be about 1-2 cm. The rod or fused fibre 22 may be made from fused silica, stainless steel and/or platinum. FIG. 5c illustrates a microextraction by packed sorbent (MEPS) barrel insert 3 for use in MEPS. The MEPS barrel insert 3 contains a packed sorbent bed of PDMS-MD composite 31 between two frits 32. The packed bed 31 may contain about 1-2 mg of the PDMS-MD composite. The PDMS-MD composite may be porous. In use, a loaded sample solution is pushed by a plunger through needle 33 into the packed sorbent bed 31 and out towards the barrel of the needle. The MEPS barrel insert 3 may include an end plug 34 and a sealing ring 35.

### Effect of MD Content on the Structural Stability of PDMS-MD Composites

To assess the effects of including MD on the structural stability of PDMS-MD composites, the swelling ratios of sample 8 and corresponding comparative sample 10 in dichloromethane (DCM) were determined following the procedure described in Lee et al. (Lee, J. N., C. Park, and G. M. Whitesides, Solvent Compatibility of Poly(dimethylsiloxane)-Based Microfluidic Devices. Analytical Chemistry, 2003. 75(23): p. 6544-6554). Briefly, the rods were soaked in DCM for 24 hours in sealed containers. The swelling ratio (S) of the composites was calculated based on the following formula:

S=L/L₀,

where L is the length of the rods in DCM and L₀ is the length of the dry rods.

The swelling ratio obtained for comparative sample 10 was 1.27, which was similar to that previously reported in Lee et al. and Ochiai et al. (Ochiai, N., et al., Solvent-assisted stir bar sorptive extraction by using swollen polydimethylsiloxane for enhanced recovery of polar solutes in aqueous samples: Application to aroma compounds in beer and pesticides in wine. Journal of Chromatography A, 2016. 1455: p. 45-56). The swelling ratio obtained for sample 8 was 1.13, which is about 12% lower than that of comparative sample 10. These results indicate that the incorporation of MD can increase the rigidity of PDMS-MD composites in organic solvents.

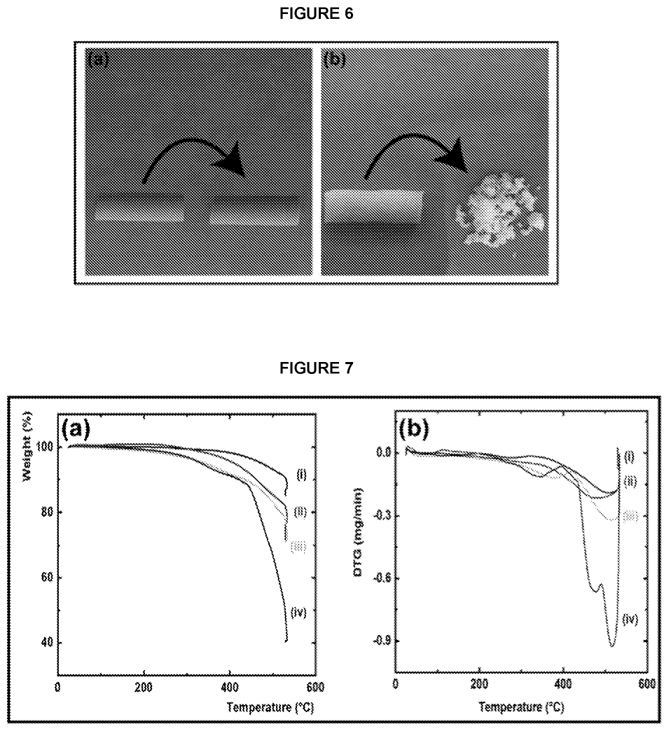

The rigidity and integrity of samples 7 and 11 and corresponding comparative sample 9 were also evaluated after using the rods for the extraction of organic compounds from wine samples. Sample 7 (FIG. 6a) and sample 11 were found to retain their rigidity and integrity after several extractions. However, sample 9 disintegrated by gentle touch after a single extraction (FIG. 6b). These results demonstrate that the incorporation of MD can improve the structural stability of PDMS-MD composites. The results also indicate the suitability of PDMS-MD composites for re-use.

### Effect of MD Content on the Thermal Stability of PDMS-MD Composites

To assess the effect of incorporating MD on the thermal stability of PDMS-MD composites, thermogravimetric analysis (TGA) of sample 1 and corresponding comparative sample 2 in both nitrogen (N₂) and air was performed as follows:

(i) Sample 1 in N₂;

(ii) Comparative sample 2 in N₂;

(iii) Sample 1 in air; and

(iv) Comparative sample 2 in air.

TGA was performed using a Labsys Evo instrument (Setaram, Caluire, France) maintaining a heating rate of 10° C./min from 25° C. to 550° C. The TGA was conducted following the procedure of Chen et al. (Chen et al. Thermal stability, mechanical and optical properties of novel addition cured PDMS composites with nano-silica sol and MQ silicone resin. Composites Science and Technology, 2015, 117:307-314) with slight modification. Briefly, approximately, 10 mg of PDMS-MD composite sample was heated in an aluminum crucible in both N₂ and air atmosphere maintain a heating rate of 10° C./min from 25° C. to 550° C.

The results are illustrated in FIG. 7, where the thermal stability plots are shown in FIG. 7a and degradation plots are shown in FIG. 7b. The data are also shown in Table 2 below.

TABLE 2

| | | | | | | Temperature for | | |
|---|---|---|---|---|---|---|---|---|
| Sample | Weight loss (%) | | | | | weight loss (° C.) | | |
| name | 100° C. | 200° C. | 300° C. | 400° C. | 500° C. | 5% | 10% | 15% |
| (i) Sample 1 in N₂ | 0 | 0 | 0 | 2 | 6 | 480 | 535 | 536 |
| (ii) Sample 2 in N₂ | 0 | 0 | 0 | 4 | 14 | 418 | 469 | 510 |
| (iii) Sample 1 in air | 0 | 1 | 3 | 8 | 17 | 343 | 436 | 486 |
| (iv) Sample 2 in air | 0 | 1 | 3 | 9 | 34 | 332 | 419 | 454 |

Sample 1 and comparative sample 2 were shown to have higher thermal stability in N₂ than in air. Both sample 1 and comparative sample 2 had a higher rate of decomposition in air than in N₂. In addition, as shown in Table 2, both sample 1 and comparative sample 2 did not show any weight loss below 300° C. in N₂, but did show weight loss at this temperature in air.

Sample 1 was shown to have higher thermal stability than comparative sample 2 both in N₂ and in air. The percentage weight losses of sample 1 in N₂ and in air were respectively lower than the percentage weight losses for comparative sample 2. In addition, as shown in Table 2, the temperatures for weight loss for sample 1 in N₂ and in air were respectively higher those for comparative sample 2. The differences between the temperature for weight loss in air for sample 1 and comparative sample 2 at 5%, 10% and 15% weight loss were 10° C., 17° C. and 26° C., respectively. The differences between sample 1 and comparative sample 2 was more pronounced in N₂ for weight loss at 5%, 10%, the differences in temperature being 62° C. and 66° C., respectively. This difference decreased to 26° C. at temperatures for 15% weight loss. These results demonstrate that the incorporation of MD can increase the thermal stability of PDMS-MD composites. The results also indicate the suitability of PDMS-MD composites for use in thermal desorption.

### Effect of MD Content on the Thermal Conductivity of PDMS-MD Composites

To assess the effect of incorporating MD on the thermal conductivity of PDMS-MD composites, the thermal conductivities of sample 7 and comparative sample 2 were determined using a C-Therm TCi Thermal Conductivity Analyser (C-Therm Technologies Ltd., Canada).

The thermal conductivity of comparative sample 2 was determined to be 0.385 W·m⁻¹·K⁻¹. The thermal conductivity of sample 7 was determined to be 0.804 W·m⁻¹·K, which is about 108% higher than that of comparative sample 2. These results demonstrate that incorporation of MD can increase the thermal conductivity of PDMS-MD composites. Due to the fact that MD can be incorporated into the PDMS matrix at much higher loadings than nanodiamond (e.g. 60wt % for sample 7, compared to less than 3 wt. % for nanodiamond), and combined with the comparatively high polarity of the surface and increased aggregation in the non-polar matrix, a significant improvement in thermal conductivity can be achieved.

### Cleaning and Mass Monitoring of PDMS-MD Composites

Methods of purifying and cleaning PDMS-MD composites were evaluated. The methods involve soaking PDMS-MD composites in methanol, followed by analysis of leachates using an Agilent 7890A GC system equipped with flame ionisation detector (FID) and BP5 chromatographic column (15 m×250 μm O.D.×0.25 μm I.D.). The analyses were performed in a flow (1.6 ml/min) of H₂ as carrier gas. The column oven temperature programming included: initial temperature, 50° C. (holding for 1 min), ramping 20° C./min, leading to a final temperature, 300° C. (holding for 3 min). The FID is detector parameters were set as temperature (300° C.), H₂ flow (30 ml/min), and air flow (340 ml/min). The injection mode was splitless, setting front inlet temperature as 250° C.

To assess the effect of thermally treating the PDMS-MD composite, thermally treated and thermally-untreated samples were evaluated. In the first set of experiments, the PDMS-MD rods (sample 7) were cut into 1 mm thick discs, which were heat treated by heating at 280° C. in a furnace with N₂ flow for 8 hours. Every hour, one disc was removed from the furnace for further analysis. Each of the thermally treated discs was then soaked in methanol for 1 hour, followed by analysis of leachates by GC-FID. In the second set of experiments, eight thermally-untreated PDMS-MD discs were soaked in methanol in separate glass vials. Every hour, the leachate solution from each vial was analysed by GC-FID.

FIG. 8 illustrates GC-FID chromatograms of leached siloxanes (*) from samples after 1 hour of soaking in methanol without thermal treatment (chromatogram a) and after 1 hour of thermal treatment and 1 hour of soaking in methanol (chromatogram b). FIG. 8 shows that low molecular weight siloxanes were detected in chromatogram a, which did not undergo heat treatment. Leached siloxanes were also detected in the chromatograms of other composites that did not undergo thermal treatment, even after 8 hours of soaking in methanol. On the other hand, no siloxanes were observed in the samples that underwent heat treatment for 1 hour and were subsequently soaked in methanol for 1 hour, as is evident from chromatogram b in FIG. 8. Similarly, no siloxanes were observed in chromatograms of other composites that underwent 2, 3, 4, 5, 6, 7 or 8 hours of thermal treatment prior to 1-hour soaking in methanol. These results demonstrate that heat treating the PDMS-MD composites can decrease the release of siloxane impurities from the composite. The results also suggest that the combination of thermal treatment and methanol soaking of the PDMS-MD composites could provide a suitable method for cleaning the composites.

In the third set of experiments, the kinetics of leaching impurities from thermally untreated PDMS discs (sample 7) was investigated by soaking 10 discs in 10 ml of methanol. Every hour, a 50 μl aliquot was taken and analysed by GC-FID. FIG. 9 illustrates the kinetics of siloxane impurities (□=impurity A, ◯=impurity B, Δ=impurity C) leached following soaking in methanol for different time periods. The maximum rate of leaching of each of the impurities was observed about 1 hour after soaking in methanol. The leaching rate appeared to decrease after 2 hours and 3 hours, and fluctuated up until 8 hours. The maximum amount of each of the impurities was observed at about 48 hours. These results suggest that soaking the PDMS-MD composites in methanol for 48 hours could be sufficient for purifying the composites.

In the fourth set of experiments, the PDMS-MD rods (sample 7 and sample 8) were cleaned by either Soxhlet extraction in methanol for 48 hours or the combination of thermal treatment at 280° C. in a N₂ flow for 1 hour and Soxhlet extraction in methanol for 48 hours. The combination of thermal treatment followed by Soxhlet extraction was found to provide more purified material than Soxhlet extraction alone. The portion of impurities eliminated from sample 8, which is non-porous, was 2.88% using the combined approach and 2.75% using the Soxhlet extraction only method, based on mass loss. In the case of sample 7, which is porous, the mass loss using the combined approach was 11.2%, which is more than 3 times higher that of than non-porous sample 8. The higher mass loss in case of porous composites could be related to the porous structure of the composites, which have a higher surface area and could therefore provide better mass transfer for the release of leachates from the PDMS base as compared to the non-porous composites. This is supported by a previous report by Toub (Toub, M., Factors affecting silicone volatile levels in fabricated silicone elastomers. Rubber world, 2002. 226(3): p. 36-39), who stated that the evaporation of low molecular weight silicones from silicone elastomers is limited by their migration from the bulk of the material to the surface, and is correlated with the geometry (e.g. thickness) and porosity (surface area) of the material. These results demonstrate that the combination of thermal treatment at 280° C. in a N₂ flow for 1 hour and Soxhlet extraction in methanol for 48 hours could be a suitable method for cleaning PDMS-MD composites.

In the fifth set of experiments, the PDMS-MD rods (samples 7, 8, 10 and 11) were cleaned by Soxhlet extraction in toluene for 72 hours. The rods were then soaked in 10 ml methanol and sonicated three times for 10 min each time with fresh methanol, followed by oven drying at 150° C. for 6 hours. The initial oven temperature was set 70° C. (holding for 5 min), ramping 10° C./min to final temperature 150° C. (holding for 6 hours). This method increased removal of unbound siloxanes with respect to the combined approach (thermal treatment and Soxhlet extraction in methanol). These results demonstrate that Soxhlet extraction in toluene for 72 hours could be a suitable method for cleaning PDMS-MD composites.

In the sixth set of experiments, after fresh porous and non-porous PDMS-MD rods were prepared (i.e. immediately after the composite mixture was cured), the rods (sample 8 and sample 11) were thermally treated at 350° C. in a He flow (2.5 mL/min) for 12 hours. No siloxane bleeding was observed from the porous and non-porous PDMS-MD composites in GC-FID chromatograms of the samples, which were similar to the control chromatograms. These results demonstrate that thermal treatment at 350° C. in a He flow for 12 hours could be a suitable method for cleaning PDMS-MD composites. This thermal treatment method may advantageously provide a more environmentally friendly and time-saving cleaning method than the above methods involving Soxhlet extraction.

### Application of PDMS-MD Composites in Extracting Organic Compounds

To assess the effectiveness of PDMS-MD composites as sorption devices, in a first experiment, PDMS-MD rods (samples 7 and 8) were used for the extraction of organic compounds from white wine samples. For comparison, a commercially available PDMS device, the Gerstel PDMS Twister, was also used. The devices were evaluated following the Gerstel application note (Nie, Y. and E. Kleine-Benne, Using three types of twister phases for stir bar sorptive extraction of whisky, wine and fruit juice. Gerstel Application Note-3, 2011) with minor modification. Specifically, the devices were placed in 10 ml gas tight vials with 5 ml of sauvignon blanc wine (11.5% EtOH v/v) for 60 min, shaking manually every 10 min. Then devices were transferred to new gas tight vials and the absorbed compounds were back extracted in 0.5 ml of methanol for 30 min, shaking manually every 5 min. The methanol extracts were analysed by direct injection in a GC-MS system. Control samples were also evaluated following a similar procedure, where the devices were exposed to 0.5 ml of methanol.

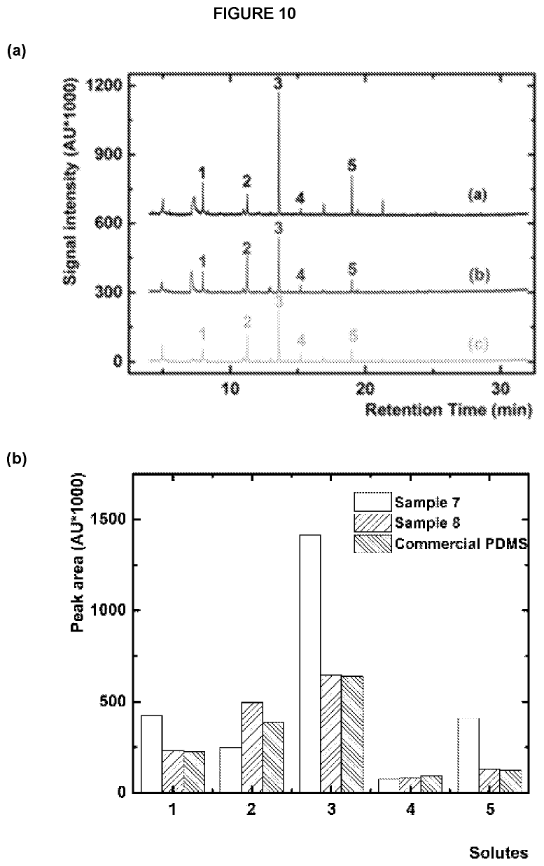

The results are illustrated in FIG. 10. FIG. 10a shows the chromatograms of organic compounds (1=ethyl hexanoate, 2=phenethyl alcohol, 3=ethyl octanoate, 4=phenethyl acetate, 5=ethyl decanoate) detected when using sample 7 (chromatogram a), sample 8 (chromatogram b) or the Gerstel PDMS Twister (chromatogram c). FIG. 10b shows the chromatographic peak area of white wine compounds obtained using sample 7 and sample 8 compared to the Gerstel PDMS Twister. These results show that both the porous and non-porous PDMS-MD composites, samples 7 and 8, appeared to have a higher absorption efficacy than the Gerstel PDMS Twister. For example, the peak areas of ethyl hexanoate, phenethyl alcohol, ethyl octanoate and ethyl decanoate in the extracts obtained by using sample 8 were higher than those obtained using the Gerstel PDMS Twister. In addition, the peak areas of ethyl hexanoate, ethyl octanoate and ethyl decanoate in the extracts obtained by using sample 7 were much higher than those obtained using either sample 8 or the Gerstel PDMS Twister. These results demonstrate that both porous and non-porous PDMS-MD composites can be used for the extraction and determination of organic compounds from samples. The results also indicate that PDMS-MD composites can be more effective than PDMS-based sorption devices under certain conditions.

In a second experiment, PDMS-MD rods (samples 7, 8 and 11) were used for the extraction of organic compounds both from synthetic and real white wine samples in experiments involving extraction, liquid desorption (LD), and GC-FID analysis. The commercially available Gerstel PDMS Twister was also used for comparison. The organic compounds included isoamyl acetate (IA), ethyl hexanoate (EH), ethyl octanoate (EO), ethyl decanoate (ED), and phenethyl acetate (PA) as model solutes. Individual standard solutions of each test solute were prepared by weight in absolute ethanol, followed by a global stock solution, containing all the test solutes, in a synthetic wine matrix (12% v/v of absolute ethanol, 5 g/L of tartaric acid and pH adjusted to pH 3.3 by adding NaOH solution dropwise) as described in Perestrelo et al. (R. Perestrelo, J. M. F. Nogueira, and J. S. Camara, Potentialities of two solventless extraction approaches-Stir bar sorptive extraction and headspace solid-phase microextraction for determination of higher alcohol acetates, isoamyl esters and ethyl esters in wines. Talanta, 2009, 80, 622-630). The devices were evaluated following the Gerstel application note and the procedure described in Perestrelo et al. with minor modification. Specifically, for all extraction experiments, each of the rods was immersed in 5 ml of wine sample and agitated at 200 rpm for 60 minutes. Following the extraction, stainless steel tweezers (cleaned with methanol) were used to remove the rods from the clear glass vials. The removed rods were gently cleaned with lint-free tissue paper and then immersed in gas chromatography (GC) vials containing 1 ml methanol and sonicated for 15 minutes at ambient temperature. After sonication, the rods were removed from the GC vials using a stainless-steel hook (cleaned with methanol). In separate glass vials, the rods were washed first with methanol and then with DIW, each time with 5 min of ultrasonication. The rods were then dried with lint-free tissue paper, followed by thermal treatment at 280° C. for 30 min in a GC inlet with He flow (2.5 mL min⁻¹). A carryover test was performed after regenerating the rods. Similar extraction and back-extraction procedures were followed for blanks (non-spiked synthetic wine). The chromatographic analysis of wine extracts was performed using a Thermo Trace GC-FID Ultra system and a BP20 capillary column (30 m×250 μm×0.25 μm L×O.D.×I.D.) obtained from SGE Analytical Science (Trajan Scientific and Medical, VIC, Australia). The He carrier gas was maintained at a constant flow rate of 1.2 mL/min. Splitless injection (1 min) mode with an injection volume of 1 μL was performed at 230° C. The oven temperature programs were set as follows: initial temperature 40° C. (holding for 2 min) and final temperature 220° C. (holding for 2 min), ramping at 7° C./min. The FID parameters were set as base temperature (260° C.), air flow (350 mL/min), H₂ flow (35 mL/min), and N₂ flow (40 mL/min). Peak areas of the solutes were integrated using Xcalibur software (Thermo, USA). The recovery of test solutes from synthetic wine sample was calculated based on the following formula:

Recovery (%)=(C₁−C₀/C₂)×100

where C₀ is the concentration of organic compound detected in the synthetic wine sample, C₁ is the concentration of organic compound detected in the spiked synthetic wine and the C₂ is the actual concentration of organic compound added to the synthetic wine sample (to produce the spiked synthetic wine sample).

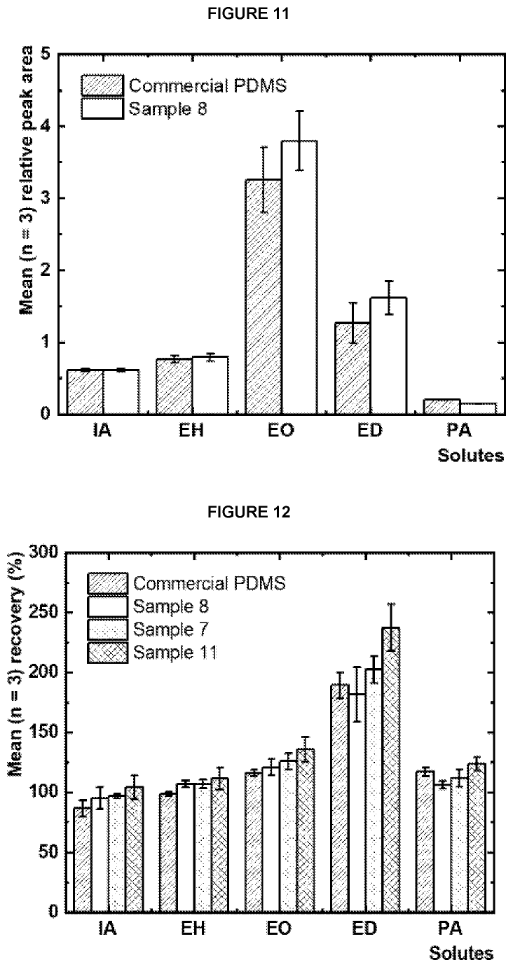

Methanol was found to be a suitable liquid desorption solvent. As shown in FIG. 11, each of the test solutes present in the synthetic wine sample were desorbed from sample 8 and the Gerstel PDMS Twister when using methanol as the desorption solvent.

FIG. 12 shows the percentage recovery of the test solutes from the synthetic wine sample over 3 experiments using samples 7, 8 and 11 compared to the Gerstel PDMS Twister. The results show that each of the rods had a high extraction efficiency, with calculated percentage recoveries ranging from about 87% to over 100% for all test solutes. The porous PDMS-MD composites, samples 7 and 11, exhibited >10-20% higher percentage recovery of the test solutes compared to the Gerstel PDMS Twister. Samples 7 and 11 also exhibited about 20-30% higher percentage recovery of the test solutes than the non-porous sample 8. In addition, the recovery of the test solutes using samples 7, 8 and 11 was found to be higher than previous studies described in Perestrelo et al. and Ceolho et al. (E. Coelho, R. Perestrelo, N. R. Neng, J. S. Camara, M. A. Coimbra, J. M. F. Nogueira, S. M. Rocha, Optimisation of stir bar sorptive extraction and liquid desorption combined with large volume injection-gas chromatography-quadrupole mass spectrometry for the determination of volatile compounds in wines. Analytica Chimica Acta, 2008, 624, 79-89).

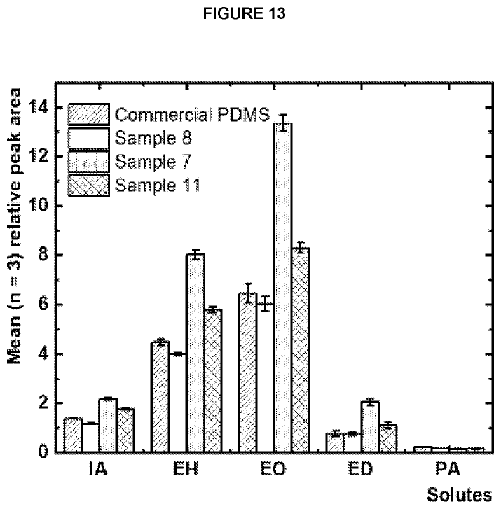

FIG. 13 shows the chromatographic peak area of white wine compounds obtained using samples 7, 8 and 11 compared to the Gerstel PDMS Twister. These results show that both the porous and non-porous PDMS-MD composites appeared to have a comparable or higher absorption efficacy than the Gerstel PDMS Twister. For example, the peak areas of isoamyl acetate, ethyl hexanoate, ethyl octanoate, ethyl decanoate and phenethyl acetate obtained by using sample 8 were comparable to those obtained using the Gerstel PDMS Twister. In addition, the peak areas of these solutes in the extracts obtained by using samples 7 and 11 were much higher than those obtained using either sample 8 or the Gerstel PDMS Twister. The amounts of the organic compounds in the white wine sample obtained using samples 7, 8, 11 and the Gerstel PDMS Twister compared to the previous studies described in Coelho et al. and Perestrelo et al. are shown in Table 3 below.

TABLE 3

| | Mean (n = 3) concentration (μg/L) | | | | | |
|---|---|---|---|---|---|---|
| | Gerstel | | | | Concentration (μg/L) | |
| | PDMS | | | | Coelho | Perestrelo |
| Solutes | twister | Sample 7 | Sample 9 | Sample 11 | et al. | et al. |
| Isoamyl | 770.42 ± 5.82 | 810.39 ± 12.96 | 904.88 ± 26.72 | 895.49 ± 19.52 | 8.5- | 270.51- |
| acetate | (0.8) | (1.6) | (3.0) | (2.2) | 52.6 | 881.91 |
| Ethyl | 1051.06 ± 29.38 | 1142.42 ± 19.64 | 1214.21 ± 28.10 | 1072.00 ± 22.23 | 702.5- | 246.66- |
| hexanoate | (2.8) | (1.7) | (2.3) | (2.1) | 943.7 | 338.43 |
| Ethyl | 1121.22 ± 66.86 | 1086.12 ± 56.19 | 1232.43 ± 31.00 | 924.67 ± 24.93 | 706.3- | 813.13- |
| octanoate | (6.0) | (5.2) | (2.5) | (2.7) | 1092.3 | 943.47 |
| Ethyl | 196.74 ± 40.65 | 163.72 ± 27.56 | 244.86 ± 24.66 | 130.91 ± 25.44 | 136.0- | 355.42- |
| decanoate | (20.7) | (16.8) | (10.1) | (19.4) | 397.5 | 457.43 |
| Phenethyl | 147.69 ± 1.52 | 135.81 ± 1.74 | 136.56 ± 6.26 | 177.83 ± 7.44 | 2.4- | 48.37- |
| acetate | (1.0) | (1.3) | (4.6) | (4.2) | 3.4 | 84.08 |

These results demonstrate that both porous and non-porous PDMS-MD composites can be used for the extraction and determination of organic compounds from samples. The results also indicate that PDMS-MD composites can be more effective than PDMS-based sorption devices under certain conditions. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

1. A sorbent for extracting one or more organic compounds, comprising a porous polymer and microdiamond, wherein the polymer is selected from the group consisting of a polysiloxane, a polyamide, a polyimide, a polyethylene, a polyether, polyvinyl alcohol, polylactic acid, a polycarbonate, a polyepoxide, and co-polymers or blends thereof.

2. The sorbent according to claim 1, wherein the polymer is a polysiloxane.

3. The sorbent according to claim 2, wherein the polysiloxane is poly(dimethylsiloxane).

4. The sorbent according to claim 1, wherein the microdiamond has a density within the range of about 2.0 g cm⁻³ to about 4.0 g cm⁻³.

5. The sorbent according to claim 1, wherein the microdiamond has a particle size within the range of about 1 μm to about 20 μm.

6. The sorbent according to claim 1, wherein the microdiamond has a particle size within the range of about 1 μm to about 10 μm.

7. The sorbent according to claim 1, wherein the microdiamond has a particle size within the range of about 2 μm to about 4 μm.

8. The sorbent according to claim 1, wherein the polymer has a density of greater than about 1.0 g cm⁻³.

9. The sorbent according to claim 1, wherein the sorbent is in the form of a solid rod, a hollow rod, a sphere, a disk, a film, a membrane, a fibre, a coating or a particle.

10. The sorbent according to claim 1, wherein the microdiamond is present in an amount within the range of about 15 wt. % to about 70 wt. %, based on the total weight of the combination of polymer and microdiamond.

11. The sorbent according to claim 10, wherein the microdiamond is present in an amount within the range of about 55 wt. % to about 65 wt. %, based on the total weight of the combination of polymer and microdiamond.

12. The sorbent according to claim 1, wherein the microdiamond is present in an amount within the range of about 15 wt. % to about 60 wt. %, based on the total weight of the sorbent.

13. The sorbent according to claim 12, wherein the microdiamond is present in an amount within the range of about 30 wt. % to about 60 wt. %, based on the total weight of the sorbent.

14. The sorbent according to claim 1, wherein the polymer is present in an amount of at least 30% by weight of the sorbent.

15. The sorbent according to claim 1, wherein the sorbent is free of fillers, or comprises fillers in an amount of not more than 20%.

16. The sorbent according to claim 1, wherein the sorbent is free of nanodiamond, or comprises nanodiamond as a filler in an amount of not more than 5%.

17. The sorbent according to claim 1, wherein the sorbent is in the form of a sorption device, or forms a component of a sorption device.

18. A sorption device comprising the sorbent according to claim 1.

19. The sorption device of claim 18, in the form of a solid rod, hollow rod, sphere, disk, film, membrane, filter, fibre or column.

20. A method for extracting one or more organic compounds from a fluid, the method comprising:
contacting:
i) a carrier fluid containing one or more organic compounds, and
ii) the sorbent as claimed in claim 1,
so that one or more organic compounds are sorbed into or onto the sorbent.

21.-47. (canceled)
